(19) United States
(12) Patent Application Publication
(10) Pub. No.: US 2016/0337691 A1
(43) Pub. Date: Nov. 17, 2016

(54) SYSTEM AND METHOD FOR DETECTING STREAMING OF ADVERTISEMENTS THAT OCCUR WHILE STREAMING A MEDIA PROGRAM

(71) Applicant: ADSPARX USA INC, Dover, DE (US)

(72) Inventors: Ramesh Prasad, Thane (IN); Lilesh Sharad Ghadi, Mumbai (IN)

(21) Appl. No.: 14/860,917

(22) Filed: Sep. 22, 2015

(30) Foreign Application Priority Data
May 12, 2015 (IN) 2422/CHE/2015

(51) Int. Cl. H04N 21/44; H04N 21/845; H04N 21/462; H04N 21/81; H04N 21/442; H04N 21/439

(52) U.S. Cl. CPC H04N 21/44008; H04N 21/442; H04N 21/4394; H04N 21/462; H04N 21/812; H04N 21/8456

(57) ABSTRACT

A system for detecting streaming of advertisements that occur while streaming a media program is provided. The system includes a broadcast content receiving module, a feature extracting module, an advertisement detecting module, a weight computing module, and a neighborhood context identifying module. The broadcast content receiving module receives a broadcast content from a content source. The feature extracting module extracts video features, audio features, and metadata features associated with broadcast chunks of the broadcast content for time segments. The advertisement detecting module analyzes the video features, the audio features, and the metadata features for the time segments. The weight computing module computes final weight for validating start and end of first advertisement slot based on the weight. The neighborhood context identifying module validates a start time of a first advertisement slot based on a content type of a first broadcast chunk and a second broadcast chunk.

This application claims priority to Indian patent application no. 2422/CHE/2015 filed on May 12, 2015, the complete disclosure of which, in its entirety, is herein incorporated by reference.

### BACKGROUND

1. Technical Field

The embodiments herein generally relate to a system and method for detecting advertisements in streaming media content, and, more particularly to a system and method for detecting streaming of advertisements in streaming media content based on video feature parameters, audio feature parameters, and/or metadata feature parameters.

2. Description of the Related Art

There are many reasons for detecting advertisements that occur in a broadcast content including ensuring whether advertisements are delivered at an appropriate time, replacing advertisements with new advertisements for monetizing, etc. For example, in a live sport broadcast, any interruption due to an injury or any other event provides an opportunity for a broadcaster to show advertisements, and try to monetize the break. Hence the live sport broadcast abruptly transitions to advertisements. As soon as, the game resumes, the stream switches back to the live sport broadcast even if it involves truncating advertisements. Hence there is no opportunity to show any pattern indicating occurrence of advertisements. Prediction of occurrence of advertisements in a streaming broadcast content is challenging. For example, in case of news channels, instances at which advertisement breaks start vary dynamically, and hence the prediction of the instances are become difficult.

Typically, prediction of occurrence of advertisements in a streaming broadcast content is achieved by apriori probability model. Another prior approach that attempts to predict occurrence of advertisements rely on a brute force matching of program content with a database of advertisements. However, such prior approaches mandate a high computation power which is required to match the program content with the database of advertisements. Hence, such approaches are not suitable for near real-time applications on devices such as set top boxes and digital video recorders. Further, the database of advertisements has to be refreshed frequently with new advertisements. Updating the database may not be possible for all applications. Accordingly, there remains a need for a system and a method for detecting occurrence of advertisements in a broadcast content with less complexity and more accuracy.

### SUMMARY

In view of the foregoing, an embodiment herein provides a system for detecting streaming of advertisements that occur while streaming a media program. The system includes a memory unit, and a processor. The memory unit stores a database and a set of modules. The processor that executes the set of modules. The set of modules include (a) a broadcast content receiving module, (b) a feature extracting module, (c) an advertisement detecting module, (d) a weight computing module, and (e) a neighborhood context identifying module. The broadcast content receiving module, executed by the processor, configured to receive a broadcast content from a content source. The broadcast content includes a media program that is stitched with advertisements at one or more predefined advertisement slots. The feature extracting module, executed by the processor, extracts video features, audio features, and metadata features associated with one or more broadcast chunks of the broadcast content for one or more time segments. The advertisement detecting module, executed by the processor, that (a) analyses the video features, the audio features, and the metadata features for the one or more time segments, (b) identifies a start of a first advertisement slot corresponds to a first time segment at which a first transition occurs from the media program to the first advertisement slot by analyzing (i) a change in a video feature of the video features, (ii) a change in an audio feature of the audio features, or (iii) presence of a metadata feature of the metadata features, and (c) identifies an end of the first advertisement slot corresponds to a second time segment at which a second transition occurs back from the first advertisement slot to the media program by analyzing (a) a change in the video feature, (b) a change in an audio feature, or (c) the metadata feature. The weight computing module, executed by the processor, that (a) assigns a weight for at least one of the video feature, the audio feature, and the metadata feature based on predefined rules, and (b) computes a final weight for validating the start and the end of the first advertisement slot based on the weight. The neighborhood context identifying module, executed by the processor, that (a) obtains a first broadcast chunk that precedes the first time segment, and a second broadcast chunk that follows the first time segment, (b) performs an analysis on features selected from a group comprising of video features, audio features, and metadata features of the first broadcast chunk and the second broadcast chunk, (c) identifies content type of the first broadcast chunk and the second broadcast chunk based on the analysis, and (d) validates the start time of the first advertisement slot based on the content type of the first broadcast chunk and the second broadcast chunk.

In one embodiment, the video features associated with the one or more broadcast chunks is selected from the group comprising of: (a) a black frame, (b) a scene cut, (c) fades in a scene, (d) advertisement start and end animation frames, (e) a presence or an absence of a channel icon, (f) a shift in a position or a change in a size of the channel icon, (g) a presence of black bands on a top, a bottom, a left or a right of a video frame, (h) a size of the black bands, (i) a presence or an absence of text in commercial breaks, (j) a presence or an absence of tickers in the commercial breaks, (k) a shift in a position of the tickers in the advertisements, and (1) an advisory.

In another embodiment, the audio features associated with the one or more broadcast chunks is selected from the group comprising of: a period of silence, a change in a volume level, a change of a frequency in an audio stream, a change in an audio characteristics, and a sound pattern at a start and an end of an advertisement break.

In yet another embodiment, the audio features associated with the one or more broadcast chunks is selected from the group comprising of: ID3 tags in an audio visual data container, the ID3 tags in a HLS playlist, SCTE-35 tags in the audio visual data container, the SCTE-35 tags in the HLS playlist, custom tags in the audio visual data container, the custom tags in the HLS playlist, and an electronic program guide (EPG).

In yet another embodiment, the advertisement detecting module, executed by the processor, that (a) identifies a start of a second advertisement slot corresponds to a third time segment at which a third transition occurs from the media program to the second advertisement slot by analyzing (a) a change in a video feature of the video features, (b) a change in an audio feature of the audio features, or (c) presence of a metadata feature of the metadata features, and (b) identifies an end of the second advertisement slot corresponds to a fourth time segment at which a fourth transition occurs back from the second advertisement slot to the media program by analyzing (a) a change in the video feature, (b) a change in the audio feature, or (c) the metadata feature.

In yet another embodiment, the set of modules further include a content type classifying module, executed by the processor, that classifies a content type of a broadcast chunk corresponds to the first time segment based on the final weight.

In yet another embodiment, the set of modules further include a pre-processing module, executed by the processor, that validates the content type of the broadcast chunk as the media program or an advertisement content by analyzing video features, audio features, and metadata features of broadcast chunks that are subsequent to the broadcast chunk.

In one aspect, a computer implemented method for detecting streaming of advertisements that occur while streaming a media program is provided. The method includes following steps of: (a) receiving a broadcast content from a content source, (b) extracting video features, audio features, and metadata features associated with one or more broadcast chunks of the broadcast content for one or more time segments, (c) analyzing the video features, the audio features, and the metadata features for the one or more time segments, (d) identifying a start of a first advertisement slot corresponds to a first time segment at which a first transition occurs from the media program to the first advertisement slot by analyzing (i) a change in a video feature of the video features, (ii) a change in an audio feature of the audio features, or (iii) presence of a metadata feature of the metadata features, (e) identifying an end of the first advertisement slot corresponds to a second time segment at which a second transition occurs back from the first advertisement slot to the media program by analyzing (i) a change in the video feature, (ii) a change in the audio feature, or (iii) the metadata feature, (f) assigning a weight for at least one of the video feature, the audio feature, and the metadata feature based on predefined rules, (g) computing a final weight for validating the start and the end of the first advertisement slot based on the weight, (h) obtaining a first broadcast chunk that precedes the first time segment, and a second broadcast chunk that follows the first time segment, (i) performing an analysis on features selected from a group comprising of video features, audio features, and metadata features of the first broadcast chunk and the second broadcast chunk, (j) identifying content type of the first broadcast chunk and the second broadcast chunk based on the analysis, and (k) validating the start time of the first advertisement slot based on the content type of the first broadcast chunk and the second broadcast chunk.

In one embodiment, the computer implemented method further includes classifying a content type of a broadcast chunk corresponds to the first time segment based on the final weight.

In another embodiment, the computer implemented method further includes validating the content type of the broadcast chunk as the media program or an advertisement content by analyzing video features, audio features, and metadata features of broadcast chunks that are subsequent to the broadcast chunk.

In yet another embodiment, the computer implemented method further includes (a) identifying a start of a second advertisement slot corresponds to a third time segment at which a third transition occurs from the media program to the second advertisement slot by analyzing (i) a change in a video feature of the video features, (ii) a change in an audio feature of the audio features, or (iii) presence of a metadata feature of the metadata features, and (b) identifying an end of the second advertisement slot corresponds to a fourth time segment at which a fourth transition occurs back from the second advertisement slot to the media program by analyzing (i) a change in the video feature, (ii) a change in the audio feature, or (iii) the metadata feature.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a system view illustrating an advertisement detecting server which includes an advertisement detecting tool for detecting streaming of advertisements that occur in one or more broadcast content according to an embodiment herein;

FIG. 2 illustrates an exploded view of the advertisement detecting tool of FIG. 1 according to an embodiment herein;

FIG. 3A is an exemplary table view illustrating weights that are assigned to the video features, the audio features and the metadata features associated with the broadcast content of FIG. 2 for a time segment based on predefined rules according to an embodiment herein.

FIG. 3B is a table view illustrating rules for making a decision of a content type of a current block of frames based on content type of neighborhood blocks including preceding blocks and following block by the neighborhood context identifying module of FIG. 2 according to an embodiment herein;

FIG. 4A-4D are flow diagrams that illustrate a method for detecting streaming of advertisements that occur while streaming a media program according to an embodiment herein; and

FIG. 5 illustrates a schematic diagram of a computer architecture used according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

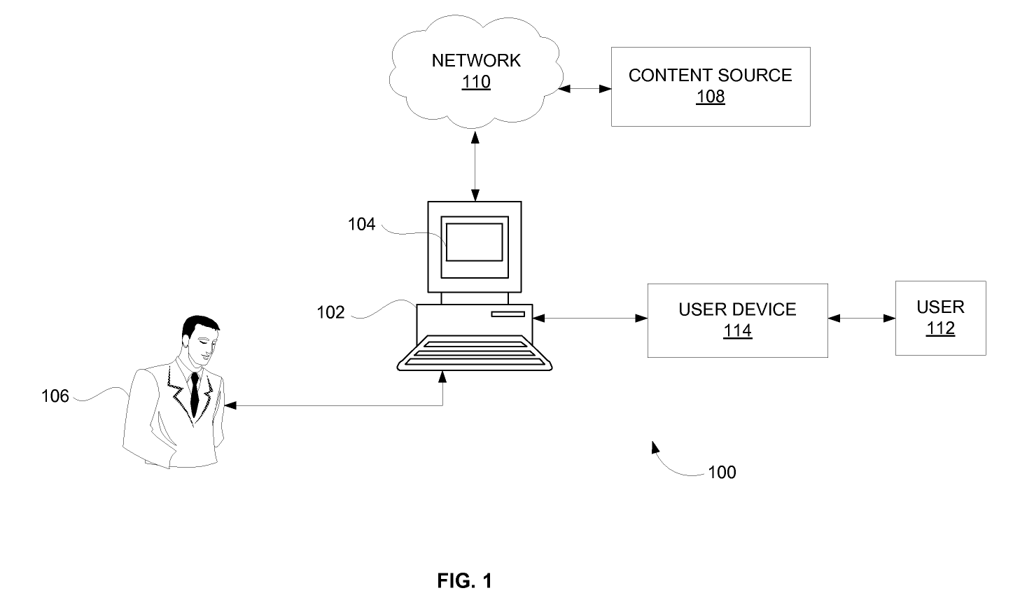

As mentioned, there remains a need for a system and method for detecting advertisements in broadcast content. The embodiments herein achieve this by providing a system and method for detecting streaming of advertisements that occur while streaming of a broadcast content (i.e. media program) based on one or more parameters such as video features, audio features, and/or metadata features of the broadcast content. Referring now to the drawings, and more particularly to FIGS. 1 through 5, where similar reference characters denote corresponding features consistently throughout the figures, there are shown preferred embodiments.

FIG. 1 is a system view 100 illustrating an advertisement detecting server 102 that includes an advertisement detecting tool 104 for detecting streaming of advertisements that occur while streaming a broadcast content according to an embodiment herein. The system view 100 further includes an administrator 106 of the advertisement detecting server 102, a content source 108, a network 110, a user 112, and a user device 114. In one embodiment, the advertisement detecting server 102 receives broadcast content from the content source 108 through the network 110. The broadcast content may be a live content or a video on demand content. In one embodiment, the advertisement detecting tool 104 detects streaming of advertisements that occur in the broadcast content in a real-time, or in a near real-time. The user 112 requests the advertisement detecting server 102 for the broadcast content using the user device 114.

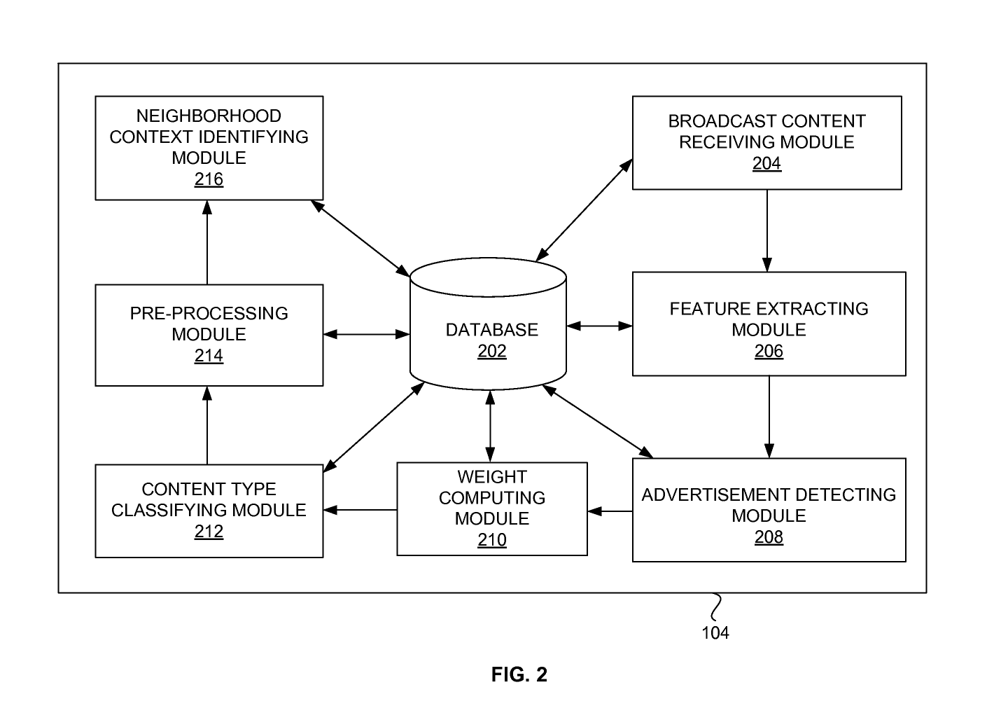

FIG. 2 illustrates an exploded view of the advertisement detecting tool 104 of FIG. 1 according to an embodiment herein. The advertisement detecting tool 104 includes a database 202, a broadcast content receiving module 204, a feature extracting module 206, an advertisement detecting module 208, a weight computing module 210, a content type classifying module 212, a pre-processing module 214, and a neighborhood context identifying module 216. The database 202 may store simulation, emulation and/or prototype data of advertisement content, and broadcast content. The broadcast content receiving module 204 receives broadcast content from the content source 108. The broadcast content includes a media program that is stitched with advertisements at one or more advertisement slots. The feature extracting module 206 extracts video features, audio features, and/or metadata features associated with one or more broadcast chunks of the broadcast content for one or more time segments. In one embodiment, extraction of video features, audio features, and/or metadata features provides data including (i) starting positions of advertisement slots, (ii) ending positions of advertisement slots, (iii) starting positions of program content, (iv) ending positions of program content, (v) transition positions at which program content shifts to advertisement slots, and (vi) transition positions at which advertisements shift back to program content. The advertisement detecting module 208 analyzes the video features, the audio features, and the metadata features for the one or more time segments. In one embodiment, the advertisement detecting module 208 includes a video feature detecting module to analyze the video features, an audio feature detecting module to analyze the audio features, and a metadata feature detecting module to analyze the metadata features for the one or more time segments. In an embodiment, the one or more time segments include a first time segment, and a second time segment. The advertisement detecting module 208 identifies a start of a first advertisement slot corresponds to a first time segment at which a first transition occurs from the media program (i.e. the broadcast content) to the first advertisement slot by analyzing (a) a change in a video feature of the video features, (b) a change in an audio feature of the audio features, or (c) presence of a metadata feature of the metadata features. The advertisement detecting module 208 further identifies an end of the first advertisement slot corresponds to a second time segment at which a second transition occurs back from the first advertisement slot to the media program by analyzing (a) a change in the video feature, (b) a change in an audio feature, or (c) the metadata feature. In one embodiment, the advertisement detecting module 208 identifies a start of a second advertisement slot corresponds to a third time segment at which a third transition occurs from the media program (i.e. the broadcast content) to the second advertisement slot by analyzing (a) a change in a video feature of the video features, (b) a change in an audio feature of the audio features, or (c) presence of a metadata feature of the metadata features. In another embodiment, the advertisement detecting module 208 identifies an end of the second advertisement slot corresponds to a fourth time segment at which a fourth transition occurs back from the second advertisement slot to the media program by analyzing (a) a change in the video feature, (b) a change in the audio feature, or (c) the metadata feature.

In one embodiment, the video feature detecting module identifies advertisement breaks that occur in a broadcast content in a near real-time by analyzing video frames of the broadcast content for a presence of a sequence of black frames, a scene cut, fades in scenes, advertisement start and end animation frames, a presence or an absence of a channel icon, a shift in a position or a change in a size of the channel icon, a presence of black bands on a top and a bottom, and/or a left and a right of a video frame, size of the black bands, a presence or an absence of text in commercial breaks, a presence or an absence of tickers in commercial breaks, a shift in a position of tickers in advertisements, and/or an advisory. In another embodiment, the video feature detecting module identifies a transition from program content to an advertisement break by analyzing a video frame for black bands on a top and a bottom of the video frame. In yet another embodiment, the video feature detecting module identifies a transition from program content to an advertisement break by analyzing a video frame for black bands on a left and a right of the video frame. However, identifying the transition using the black bands may lead to false positives some times, especially when the video frame has dark scenes. To prevent such false positives, the video feature detecting module takes a histogram of the video frame to identify overall darkness of the video frame. When the histogram is concentrated towards dark values, the video frame is considered as dark. Then, the video feature detecting module considers other features (e.g., the video features, the audio features, and/or the metadata features) in addition to the black bands for decision making on the transition.

In yet another embodiment, the video feature detecting module identifies a transition from program content to an advertisement break by analyzing a video frame for a channel logo shift, a change in size of the channel logo, and/or a presence or an absence of the channel logo. In another embodiment, the video feature detecting module identifies a transition from program content to an advertisement break by analyzing a video frame associated with a channel for a band. Examples of band include a message that keeps showing an update of a program during an advertisement break (e.g., stock updates in a news channel), a text and a timer indicating how long it takes for the program content to resume, text overlays that disappear during advertisement breaks, tickers and its position on the video frame, etc.

In yet another embodiment, the video feature detecting module identifies a transition from program content (i.e. media program) to an advertisement break by analyzing a video frame for a fixed pattern (e.g., a channel animation, and/or an audio pattern which is streamed before advertisement breaks start). Channel animations and audio patterns specific to channels may be stored already in the database 202. The video frame is compared with the channel animations which are already stored in the database 202 for a match, and to determine the transition. In one embodiment, the video feature detecting module identifies a transition from program content to an advertisement break by identifying a dark frame. Presence of the dark frame may indicate the transition from the program content to the advertisement break, or vice versa. The video feature detecting module identifies shifts from an advertisement break to a program content of an ongoing program, or a new program. The video feature detecting module may identify the transition from the advertisement break to the program content by analyzing the video frame for an advisory or a parental guidance rating.

In one embodiment, the audio feature detecting module identifies advertisement breaks that occur in a broadcast content in a near real-time by analyzing audio streams of the broadcast content for a period of silence, a change in a volume level, a change in an audio characteristics (e.g., beats, a rhythm, a tempo, etc.), and/or a sound pattern at a start and an end of an advertisement break.

In one embodiment, the audio feature detecting module identifies a transition from program content to an advertisement break by analyzing an audio stream for a silence period, or a change in an audio features include beats, rhythm, tempo etc., which all indicates starting of the advertisement break. The audio feature detecting module identifies a change of a frequency in the audio stream for detecting the transition.

In one embodiment, the metadata feature detecting module identifies advertisement breaks that occur in a broadcast content in a near real-time by analyzing metadata of the broadcast content for ID3 tags in an audio visual data container, ID3 tags in a HLS playlist, SCTE-35 tags in an audio visual data container, SCTE-35 tags in a HLS playlist, custom tags in an audio visual data container, custom tags in a HLS playlist, and/or an electronic program guide (EPG).

In one embodiment, the metadata feature detecting module identifies a transition from program content to an advertisement break by analyzing a broadcast content for a presence of ID3 tags within an audio visual stream. For example, ID3 tags inserted packet Elementary Stream (PES) packets in a Transport Stream (TS) packet. The PES packets contain timestamps and auxiliary data regarding advertisement breaks. The timestamps of ID3 PES packets indicate exact time at which advertisements breaks are going to start or end. The exact time of the start or end of the advertisement breaks may also be signaled as a payload within the ID3 PES packets. The ID3 PES packets are also used to alert the advertisement detecting tool 104 for upcoming advertisement breaks.

In one embodiment, the metadata feature detecting module identifies a transition from program content to an advertisement break by analyzing a broadcast content for a presence of ID3 tags in a HLS playlist. The ID3 PES packets are signaled as a metadata in a playlist file (e.g., .m3u8) of the HLS protocol. A playlist parser parses the ID3 PES packets, and identifies advertisements or program content. In another embodiment, the metadata feature detecting module identifies a transition from program content to an advertisement break based on the electronic program guide (EPG) that are available as application program interface (API).

The weight computing module 210 that is configure to assign a weight for at least one of the video feature, the audio feature, and the metadata feature based on predefined rules. The weight computing module 210 further configured to compute a final weight for validating the start and end of the first advertisement slot based on the weight. For example, if the broadcast content includes ID3 tags which indicate start time and end time of advertisement breaks in the broadcast content, then the weight computing module 210 assigns a 100% weight for the ID3 tags feature. In another example, if there is a known pattern precedes an advertisement break in a broadcast content, the weight computing module 210 may assign 50% weight to the video features and 50% weight to the audio features. In one embodiment, a weight computed by the weight computing module 210 is dynamic. For example, a weight given to dark bands may be reduced when an entire video frame is found to be dark, and accordingly the weight varies.

The content type classifying module 212 classifies a content type of a broadcast chunk corresponds to the first time segment based on the final weight. In one embodiment, classification of the video frame or the audio stream is performed using a support vector machine (SVM). Features (e.g., video, audio, and/or metadata) of the broadcast content is used as an input to a trained SVM based classifier which outputs a classification as program content or an advertisement. To train a SVM based classifier, a known sequence of features and outputs specified as content or commercials are provided. During training, the SVM classifier finds an optimum threshold for each of the features to classify it as an advertisement or program content.

The pre-processing module 214 is configured to validate a content type of a broadcast chunk as the media program (i.e. the program content) or an advertisement content by analyzing video features, audio features, and metadata features of broadcast chunks that are subsequent to the broadcast chunk. In one embodiment, the pre-processing module 214 is implemented as a state machine. When the state machine starts, it obtains the content type from the content type classifying module 212. Once, the state machine obtains the content type of the broadcast chunk, the state machine transitions to content observe state or an advertisement observe state based on the content type. The state machine validates a decision on the content type by the content type classifying module 212 by accumulating triggers from subsequent video frames or audio streams.

A number of subsequent video frames and/or audio streams to be analyzed are defined by a predefined configurable threshold. Based on analyzing of subsequent video frames or audio streams as defined by the predefined configurable threshold, the state machine validates the decision on the content type. When validating the content type, the state machine increases a confidence of the content type. A positive threshold is set to be much higher than a threshold of an observe state, and a negative threshold may be same as the threshold of the observe state. Once a confidence level exceeds the threshold, the state machine validates the content type as either an advertisement or program content.

The neighborhood context identifying module 216 is configured to (a) obtain a first broadcast chunk that precedes the first time segment, and a second broadcast chunk that follows the first time segment, (b) perform an analysis on features selected from a group comprising of video features, audio features, and metadata features of the first broadcast chunk and the second broadcast chunk, (c) identify the content type of the first broadcast chunk and the second broadcast chunk based on the analysis, and (d) validate the start time of the first advertisement slot based on the content type of the first broadcast chunk and the second broadcast chunk. Examples of rules include a minimum break duration which indicates the advertisement detecting tool 104 not to signal a break which is less than a predefined configuration value, a minimum gap between advertisement breaks which indicates the advertisement detecting tool 104 not to signal a break if a difference between two consecutive advertisement breaks is less than a predefined value, and a maximum break duration which indicates the advertisement detecting tool 104 to limit a maximum break duration to a predefined value.

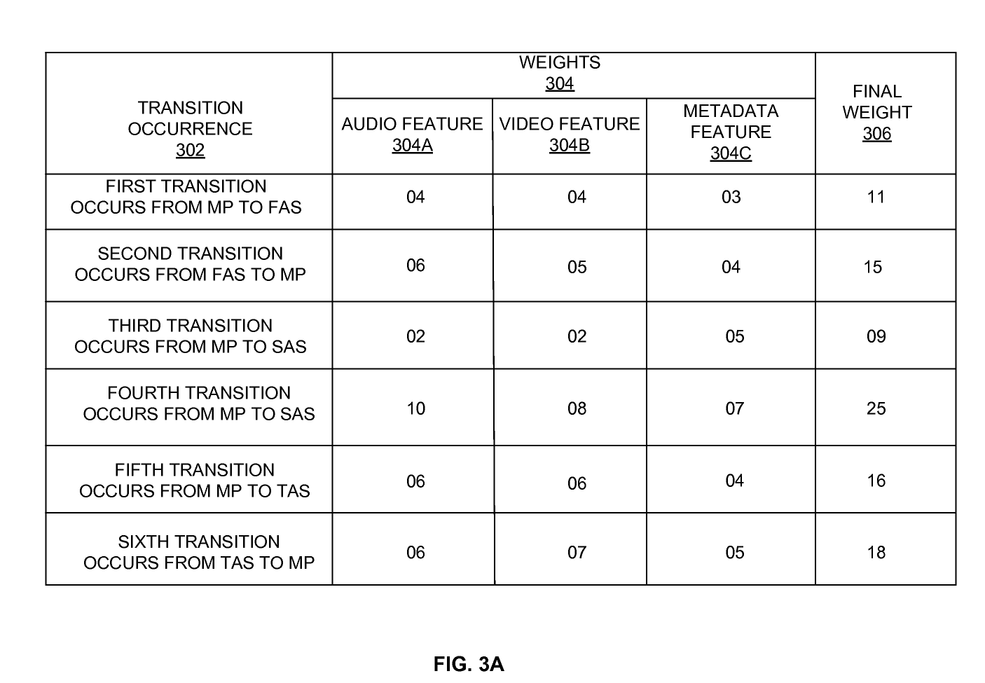

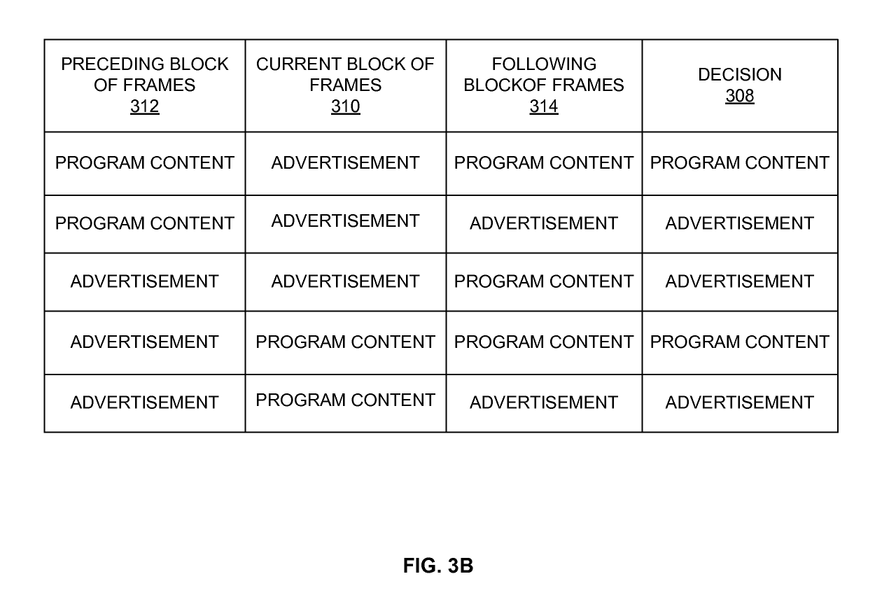

FIG. 3A is an exemplary table view illustrating weights that are assigned to the video features, the audio features and the metadata features associated with the broadcast content of FIG. 2 for a time segment based on predefined rules according to an embodiment herein. During the first transition that occurs from media program (MP) to first advertisement slot (FAS), a weight is assigned by the weight computing module 210 for each of at least one of the video feature, the audio feature, and the metadata feature associated with the broadcast content for a first time segment based on predefined rules. A final weight for the first transition is computed by the weight computing module 210 for validating the start of the first advertisement slot based on the weight (as shown in the FIG.). Similarly, during the second transition that occurs from the first advertisement slot (FAS) to the media program (MP), a weight is assigned by the weight computing module 210 for each of at least one of the video feature, the audio feature, and the metadata feature associated with the broadcast content for a second time segment based on the predefined rules. A final weight for the second transition is computed by the weight computing module 210 for validating the end of the first advertisement slot based on the weight. Likewise, during the third transition that occurs from media program (MP) to second advertisement slot (FAS), a weight is assigned by the weight computing module 210 for each of at least one of the video feature, the audio feature, and the metadata feature associated with the broadcast content for a third time segment weight based on the predefined rules. A final weight for third transition is computed by the weight computing module 210 for validating the start of the second advertisement slot based on the weight. Similarly, during the fourth transition that occurs from the second advertisement slot (SAS) to the media program (MP), a weight is assigned by the weight computing module 210 for each of at least one of the video feature, the audio feature, and the metadata feature associated with the broadcast content for a second time segment based on the predefined rules. A final weight for fourth transition is computed by the weight computing module 210 for validating the end of the second advertisement slot based on the weight. Similarly, the weights are assigned by the weight computing module 210 to the video feature, the audio feature, and the metadata feature associated with the broadcast content for subsequent time segments during subsequent transitions to validate the start and the end of the subsequent advertisement slot based on the weights. The weights are merely examples, and it is not limiting a scope of the invention.

FIG. 3B is a table view illustrating rules for making a decision 308 of a content type of a current block of frames 310 based on content type of neighborhood blocks including preceding blocks 312 and following block 314 by the neighborhood context identifying module 216 of FIG. 2 according to an embodiment herein. As depicted in the table view, when a current block of frames 310 is an advertisement, a preceding block of frames 312 is program content, a following block of frames 314 is program content, and then the neighborhood context identifying module 216 decides the content type associated with the current block of frames 310 as program content. Similarly, when a current block of frames 310 is an advertisement, a preceding block of frames 312 is program content, a following block of frames 314 is an advertisement, and then the neighborhood context identifying module 216 decides the content type associated with the current block of frames 310 as an advertisement.

Likewise, when a current block of frames 310 is an advertisement, a preceding block 312 of frames is an advertisement, a following block of frames 314 is program content, and then the neighborhood context identifying module 216 decides the content type associated with the current block of frames 310 as an advertisement. Likewise, when a current block of frames 310 is program content, a preceding block of frames 312 is an advertisement, a following block of frames 314 is program content, and then the neighborhood context identifying module 216 decides the content type associated with the current block of frames 310 as program content. Likewise, when a current block of frames 310 is program content, a preceding block of frames 312 is an advertisement, a following block of frames 314 is an advertisement, and then the neighborhood context identifying module 216 decides the content type associated with the current block of frames 310 as an advertisement. The rules are merely examples, and it is not limiting a scope of the invention.

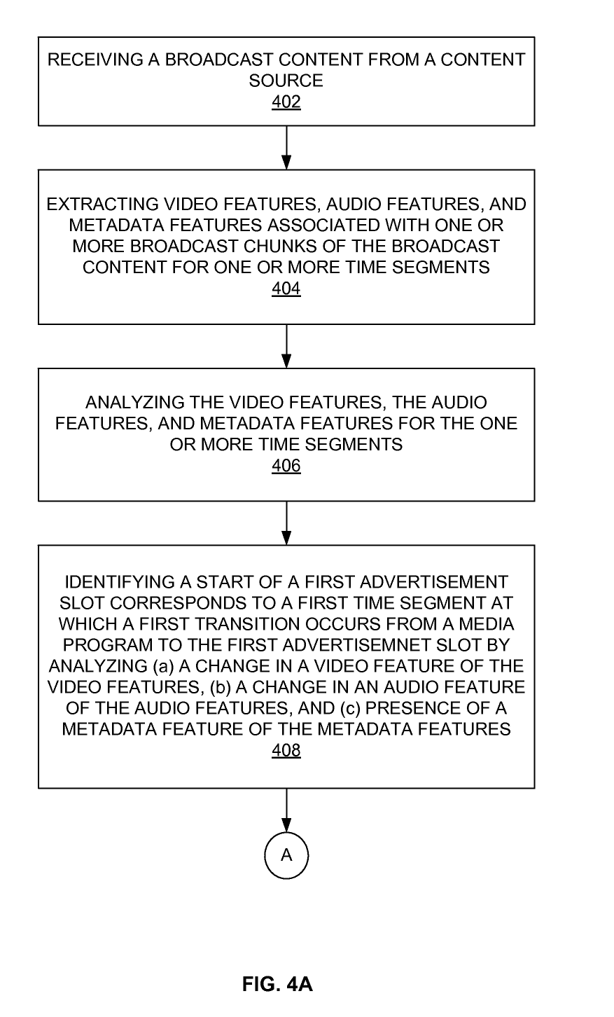

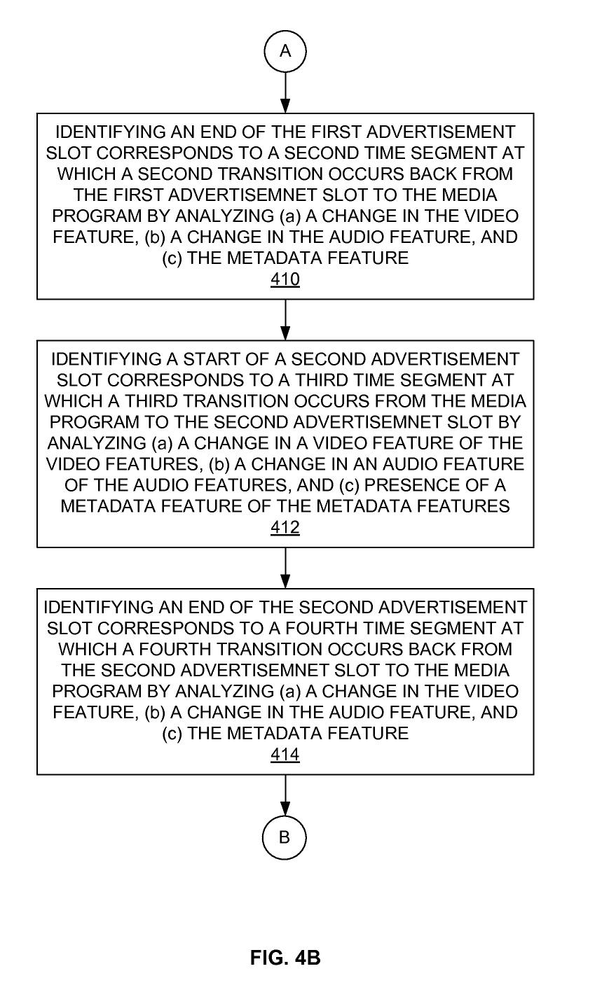

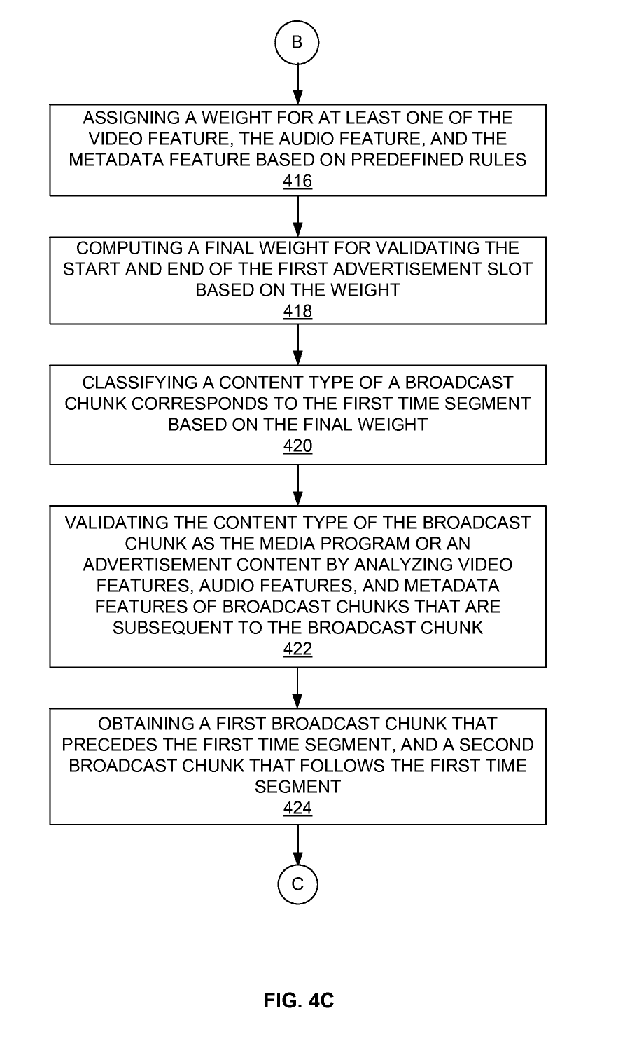

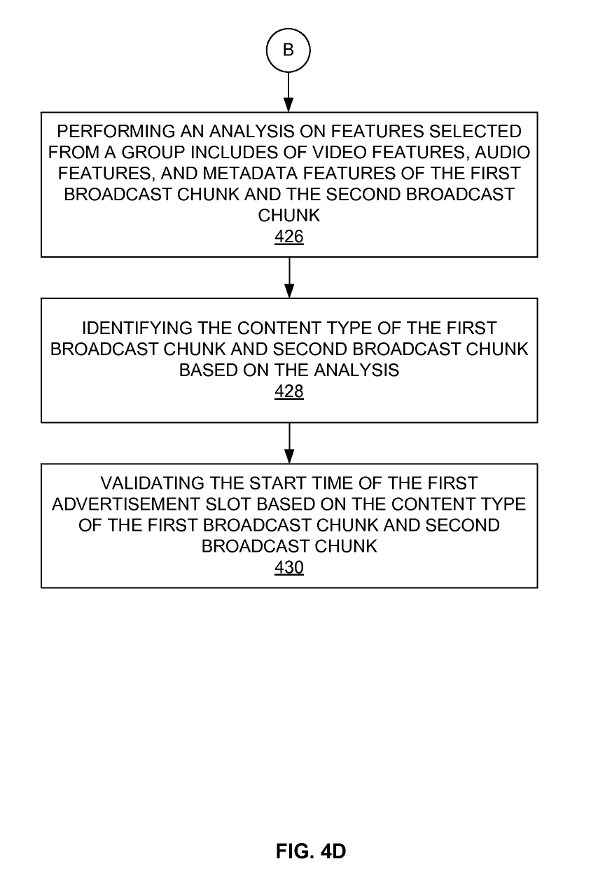

FIG. 4A-4D are flow diagrams that illustrate a method for detecting streaming of advertisements that occur while streaming a media program according to an embodiment herein. At step 402, a broadcast content is received from a content source. At step 404, video features, audio features, and metadata features associated with one or more broadcast chunks of the broadcast content are extracted for one or more time segments. At step 406, the video features, the audio features, and the metadata features associated with the one or more broadcast chunks are analyzed for the one or more time segments. At step 408, a start of a first advertisement slot corresponding to a first time segment at which a first transition occurs from the media program to the first advertisement slot is identified by analyzing (a) a change in a video feature of the video features, (b) a change in an audio feature of the audio features, or (c) presence of a metadata feature of the metadata features. At step 410, an end of the first advertisement slot corresponding to a second time segment at which a second transition occurs back from the first advertisement slot to the media program is identified by analyzing (a) a change in the video feature, (b) a change in the audio feature, or (c) the metadata feature. At step 412, a start of a second advertisement slot corresponding to a third time segment at which a third transition occurs from the media program to the second advertisement slot is identified by analyzing (a) a change in a video feature of the video features, (b) a change in an audio feature of the audio features, or (c) presence of a metadata feature of the metadata features. At step 414, an end of the second advertisement slot corresponding to a fourth time segment at which a fourth transition occurs back from the second advertisement slot to the media program is identified by analyzing (a) a change in the video feature, (b) a change in the audio feature, or (c) the metadata feature. At step 416, a weight is assigned for at least one of the video feature, the audio feature, and the metadata feature based on predefined rules. At step 418, a final weight is computed for validating the start and the end of the first advertisement slot based on the weight. At step 420, a content type of a broadcast chunk corresponding to the first time segment is classified based on the final weight. At step 422, the content type of the broadcast chunk as the media program or an advertisement content is validated by analyzing video features, audio features, and metadata features of broadcast chunks that are subsequent to the broadcast chunk. At step 424, a first broadcast chunk that precedes the first time segment, and a second broadcast chunk that follows the first time segment is obtained. At step 426, an analysis is performed on features selected from a group comprising of video features, audio features, and metadata features of the first broadcast chunk and the second broadcast chunk. At step 428, the content type of the first broadcast chunk and the second broadcast chunk is identified based on the analysis. At step 430, the start time of the first advertisement slot is validated based on the content type of the first broadcast chunk and the second broadcast chunk.

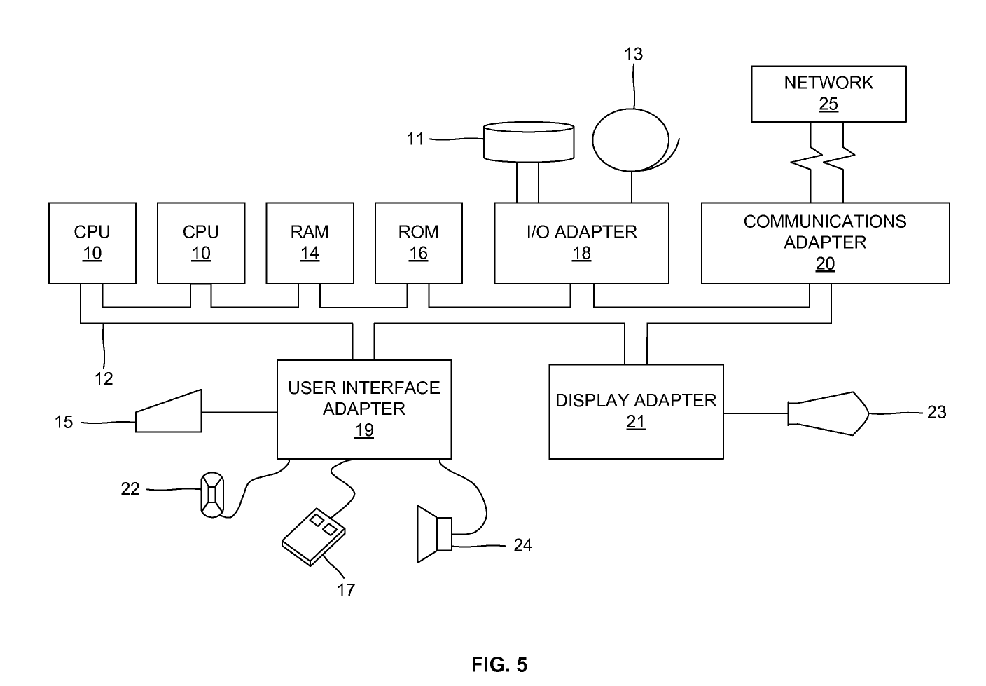

A representative hardware environment for practicing the embodiments herein is depicted in FIG. 5. This schematic drawing illustrates a hardware configuration of a computer architecture/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The system 100 is used to detect streaming of advertisement that occur while streaming the media program. The advertisement detecting tool 104 is used to detect commercial advertisements even the standard commercial advertisements are not present in the audio video streams. The system takes the commercial advertisements into the media program which are used in the TV programming The system 100 validates the decision over a period of time thus eliminating possibilities of false detection. The transition occurrence of the advertisements in the media program is less complexity and more accuracy.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A system for detecting streaming of advertisements that occur while streaming a media program, said system comprising:
a memory unit that stores a database and a set of modules; and
a processor that executes said set of modules, wherein said set of modules comprise:
(a) a broadcast content receiving module, executed by said processor, configured to receive a broadcast content from a content source, wherein said broadcast content comprises a media program that is stitched with advertisements at a plurality of predefined advertisement slots;
(b) a feature extracting module, executed by said processor, that extracts video features, audio features, and metadata features associated with a plurality of broadcast chunks of said broadcast content for a plurality of time segments;
(c) an advertisement detecting module, executed by said processor, that
(i) analyzes said video features, said audio features, and said metadata features for said plurality of time segments;
(ii) identifies a start of a first advertisement slot corresponds to a first time segment at which a first transition occurs from said media program to said first advertisement slot by analyzing (a) a change in a video feature of said video features, (b) a change in an audio feature of said audio features, or (c) presence of a metadata feature of said metadata features; and
(iii) identifies an end of said first advertisement slot corresponds to a second time segment at which a second transition occurs back from said first advertisement slot to said media program by analyzing (a) a change in said video feature, (b) a change in an audio feature, or (c) said metadata feature, and
(d) a weight computing module, executed by said processor, that
(i) assigns a weight for at least one of said video feature, said audio feature, and said metadata feature based on predefined rules; and
(ii) computes a final weight for validating said start and said end of said first advertisement slot based on said weight, and
(e) a neighborhood context identifying module, executed by said processor, that
(i) obtains a first broadcast chunk that precedes said first time segment, and a second broadcast chunk that follows said first time segment;
(ii) performs an analysis on features selected from a group comprising of video features, audio features, and metadata features of said first broadcast chunk and said second broadcast chunk;
(iii) identifies content type of said first broadcast chunk and said second broadcast chunk based on said analysis; and
(iv) validates said start time of said first advertisement slot based on said content type of said first broadcast chunk and said second broadcast chunk.

2. The system of claim 1, wherein said video features associated with said plurality of broadcast chunks is selected from the group comprising of: (a) a black frame, (b) a scene cut, (c) fades in a scene, (d) advertisement start and end animation frames, (e) a presence or an absence of a channel icon, (f) a shift in a position or a change in a size of said channel icon, (g) a presence of black bands on a top, a bottom, a left or a right of a video frame, (h) a size of said black bands, (i) a presence or an absence of text in commercial breaks, (j) a presence or an absence of tickers in said commercial breaks, (k) a shift in a position of said tickers in said advertisements, and (l) an advisory.

3. The system of claim 1, wherein said audio features associated with said plurality of broadcast chunks is selected from the group comprising of: a period of silence, a change in a volume level, a change of a frequency in an audio stream, a change in an audio characteristics, and a sound pattern at a start and an end of an advertisement break.

4. The system of claim 1, wherein said audio features associated with said plurality of broadcast chunks is selected from the group comprising of: ID3 tags in an audio visual data container, said ID3 tags in a HLS playlist, SCTE-35 tags in said audio visual data container, said SCTE-35 tags in said HLS playlist, custom tags in said audio visual data container, said custom tags in said HLS playlist, and an electronic program guide (EPG).

5. The system of claim 1, wherein said advertisement detecting module, executed by said processor, that
(i) identifies a start of a second advertisement slot corresponds to a third time segment at which a third transition occurs from said media program to said second advertisement slot by analyzing (a) a change in a video feature of said video features, (b) a change in an audio feature of said audio features, or (c) presence of a metadata feature of said metadata features; and
(ii) identifies an end of said second advertisement slot corresponds to a fourth time segment at which a fourth transition occurs back from said second advertisement slot to said media program by analyzing (a) a change in said video feature, (b) a change in said audio feature, or (c) said metadata feature.

6. The system of claim 1, wherein said set of modules further comprise a content type classifying module, executed by said processor, that classifies a content type of a broadcast chunk corresponds to said first time segment based on said final weight.

7. The system of claim 1, wherein said set of modules further comprise a pre-processing module, executed by said processor, that validates said content type of said broadcast chunk as said media program or an advertisement content by analyzing video features, audio features, and metadata features of broadcast chunks that are subsequent to said broadcast chunk.

8. A computer implemented method for detecting streaming of advertisements that occur while streaming a media program, said method comprising:
receiving a broadcast content from a content source;
extracting video features, audio features, and metadata features associated with a plurality of broadcast chunks of said broadcast content for a plurality of time segments;
analyzing said video features, said audio features, and said metadata features for said plurality of time segments;
identifying a start of a first advertisement slot corresponds to a first time segment at which a first transition occurs from said media program to said first advertisement slot by analyzing (a) a change in a video feature of said video features, (b) a change in an audio feature of said audio features, or (c) presence of a metadata feature of said metadata features;
identifying an end of said first advertisement slot corresponds to a second time segment at which a second transition occurs back from said first advertisement slot to said media program by analyzing (a) a change in said video feature, (b) a change in said audio feature, or (c) said metadata feature;
assigning a weight for at least one of said video feature, said audio feature, and said metadata feature based on predefined rules;
computing a final weight for validating said start and said end of said first advertisement slot based on said weight;
obtaining a first broadcast chunk that precedes said first time segment, and a second broadcast chunk that follows said first time segment;
performing an analysis on features selected from a group comprising of video features, audio features, and metadata features of said first broadcast chunk and said second broadcast chunk;
identifying content type of said first broadcast chunk and said second broadcast chunk based on said analysis; and
validating said start time of said first advertisement slot based on said content type of said first broadcast chunk and said second broadcast chunk.

9. The computer implemented method of claim 8, further comprising classifying a content type of a broadcast chunk corresponds to said first time segment based on said final weight.

10. The computer implemented method of claim 8, further comprising validating said content type of said broadcast chunk as said media program or an advertisement content by analyzing video features, audio features, and metadata features of broadcast chunks that are subsequent to said broadcast chunk.

11. The computer implemented method of claim 8, further comprising:
identifying a start of a second advertisement slot corresponds to a third time segment at which a third transition occurs from said media program to said second advertisement slot by analyzing (a) a change in a video feature of said video features, (b) a change in an audio feature of said audio features, or (c) presence of a metadata feature of said metadata features; and
identifying an end of said second advertisement slot corresponds to a fourth time segment at which a fourth transition occurs back from said second advertisement slot to said media program by analyzing (a) a change in said video feature, (b) a change in said audio feature, or (c) said metadata feature.
